(19) United States
(12) Patent Application Publication
(10) Pub. No.: US 2006/0290570 A1
(43) Pub. Date: Dec. 28, 2006

(54) Antenna module for the high frequency and microwave range

(75) Inventor: Achim Hilgers, Alsdorf (DE)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics, N.V., Eindhoven (NL)

(21) Appl. No.: 10/569,685

(22) PCT Filed: Aug. 23, 2004
(86) PCT No.: PCT/IB04/51531

§ 371 Date: Feb. 27, 2006

(30) Foreign Application Priority Data
Sep. 2, 2003 (EP) 03102688.3

(51) Int. Cl. H01Q 1/38

(52) U.S. Cl. 343/700 MS; 343/702

(57) ABSTRACT

A description is given of an antenna module, in particular for telecommunication in the high frequency and microwave range, which can be controlled with regard to its radiation properties and can be optimized in particular with regard to its efficiency. This is essentially achieved in that the antenna module comprises at least one antenna (1) having at least a first terminal (11) and a second terminal (12), and a circuit arrangement for the switchable splitting of an HF connection to the antenna (1) onto at least a first branch and a second branch which are connected to the first and second terminals (11, 12) of the antenna (1), respectively. The invention also relates to a circuit board and to a telecommunication device, particularly a mobile telecommunication device, comprising such an antenna module.

The invention relates to an antenna module, in particular for telecommunication in the high frequency and microwave range, which can be controlled with regard to its radiation properties. The invention also relates to a telecommunication device, particularly a mobile telecommunication device, comprising such an antenna module.

In order to transmit information by means of telecommunication devices, in particular mobile telecommunication devices, use is usually made of electromagnetic waves in the high frequency or microwave range. In order to transmit and receive these waves, there is an increasing need for antennas which can be operated in a number of frequency bands, in each case with a sufficiently large bandwidth.

In the mobile telephone standard, for example, such frequency bands lie between 880 and 960 MHz (GSM900), between 1710 and 1880 MHz (GSM- or DCS1800), and in particular in the USA between 824 and 894 MHz (AMPS) and 1850 and 1990 MHz (D-AMPS, PCS or GSM1900). They also include the UMTS band (1880 to 2200 MHz), and in particular wide-band CDMA (1920 to 1980 MHz and 2110 to 2170 MHz) and also the DECT standard for cordless telephones in the frequency band from 1880 to 1900 MHz and the Bluetooth standard (BT) in the frequency band from 2400 to 2483.5 MHz, which is used to exchange data between various electronic devices such as, for example, mobile telephones, computers, entertainment equipment, etc.

There is also a need for it to be possible to operate mobile telephones both in at least one of the GSM frequency ranges and in the UMTS frequency range, at least during a transition period.

There is also often a need to be able to operate a mobile telephone both in the two European (GSM) bands and in the two US bands (AMPS and PCS), so that users who often travel in Europe and the USA do not have to carry two mobile telephones.

Besides the transmission of information, additional functions and applications, for instance for satellite navigation purposes, are sometimes also realized in mobile telecommunication devices in the known GPS band or another frequency band in which the antenna would then also have to be able to operate.

In principle, there is therefore a need for modern telecommunication devices of this type to be able to be operated in as many of said frequency ranges as possible, so that multiband or broadband antennas which cover these frequency ranges are accordingly required.

With the increasing integration of these and other functions in mobile telephones and the simultaneous attempts that are being made to miniaturize these devices as much as possible, there is moreover a need for the antennas to have as small a volume or as small a size as possible, since there is increasingly less space available in the housings.

In order to minimize the size of the antenna at a given wavelength of the emitted radiation, a dielectric having a dielectric constant ∈ᵣ>1 may be used as basic building block for the antenna. This leads to the wavelength of the radiation in the dielectric being shortened by a factor 1/\sqrt{∈ᵣ}. An antenna designed on the basis of such a dielectric is therefore also smaller, in terms of its size, by this factor. However, one disadvantage is that as the dielectric constant increases, the bandwidth of the antenna accordingly becomes smaller.

An antenna of this type has, for example, a substrate made of a dielectric material, on the surfaces of which there are applied, depending on the desired operating frequency band or bands, one or more resonant metallization structures. The values of the resonant frequencies are dependent on the dimensions of the printed metallization structures and on the value of the dielectric constant of the substrate. The values of the individual resonant frequencies decrease as the length of the metallization structures increases and also as the values of the dielectric constant increase. Such antennas are also referred to as “Printed Wire Antennas” (PWAs) or “Dielectric Block Antennas” (DBAs).

One particular advantage of these antennas is that they can be applied directly to a printed circuit board (PCB) by surface mounting (SMD technique), that is to say by flat soldering and contacting—possibly together with other components—without additional mounting devices (pins) being required in order to supply or dissipate electromagnetic power. If desired or necessary, however, these antennas may of course also be mounted on a circuit board by means of spring pins or in some other known way and then contacted, or be applied to the side of or above the printed circuit board.

Nevertheless, the dimensioning of the metallization structures may be problematic and difficult, in particular if such an antenna is to operate in a number of frequency bands. This is because optimal adaptation of the antenna to one of the necessary frequency ranges means that the antenna performance in the other frequency ranges is impaired since the metallization structures mutually affect one another.

Another type of antenna, which is likewise used in mobile telecommunication devices, are the so-called “Planar Inverted F Antennas” (PIFAs), in which a metallization structure is arranged above a ground metallization, said antennas operating as volume resonators. In these types of antennas, multiband functionality can be achieved by one or more slits that run in a certain way or are shaped in a certain way being made in the metallization structure. As a result, the antenna can be operated in at least two different modes which can cover different frequency bands. However, one disadvantage of these antennas is that, in particular when they are of a reduced size, they cover a very narrow band on account of the high interaction between different parts of the metallization structure and can therefore fulfill the abovementioned requirements only in an unsatisfactory manner. A further disadvantage is that the antennas require a relatively large amount of space which can be reduced only to a limited extent, even by using dielectric materials.

It is therefore an object of the invention to provide an antenna, in particular for telecommunication in the high frequency and microwave range, which can be operated in at least two of the abovementioned frequency bands with a bandwidth that is sufficient for the abovementioned applications.

Furthermore, it is an object of the invention to provide an antenna of the abovementioned type which cannot merely be operated in a number of frequency bands and thus be expanded in terms of its function, but also can be miniaturized to a relatively great extent.

An antenna is also to be provided, the radiation properties of which can be controlled.

Finally, another object of the invention is also to increase the efficiency of such an antenna.

The object is achieved as claimed in claim 1 by an antenna module, in particular for the high frequency and microwave range, comprising at least one antenna having at least a first terminal and a second terminal, and a circuit arrangement for splitting an HF connection to the antenna onto at least a first branch and a second branch which are connected to the first and second terminals of the antenna, respectively.

As a result of the fact that the antenna has at least two HF terminals and the HF connection to the antenna is split onto at least two branches which are connected to these terminals, a large number of possibilities open up in respect of influencing the radiation properties of the antenna by the nature of the splitting of the HF signal onto these branches (in particular power splitting and/or phase shifting between the HF signals), so that a dimensioning that corresponds to the desired requirements can be found for almost every one of the abovementioned frequency bands or combinations of these frequency bands and thus a dual band or multiband antenna can be produced.

A further advantage of this solution is that it can in principle be implemented for all the antenna types mentioned above and for all the frequency bands or ranges mentioned above.

At this point it should be mentioned that switchable antennas having a number of ceramic layers, a number of metal layers, a plurality of radiating elements and a plurality of control circuits are known, for example, from U.S. Pat. No. 6,320,574 B1. However, since these are phased array antennas, they are not regarded as generic.

The dependent claims contain advantageous developments of the invention.

Claims 2 to 4 relate to preferred types of splitting of the HF connection or of the HF signals supplied via the latter.

Claims 5 to 9 relate to preferred embodiments of the antenna which can be used with particular advantage as part of the antenna module according to the invention and by means of which it is possible to achieve a considerable increase in efficiency.

The invention will be further described with reference to examples of embodiments shown in the drawings to which, however, the invention is not restricted.

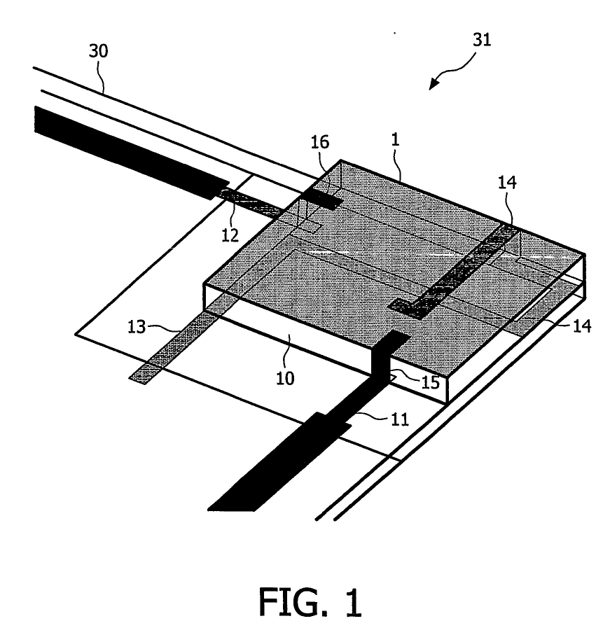

FIG. 1 shows a schematic diagram of an antenna as part of an antenna module according to the invention.

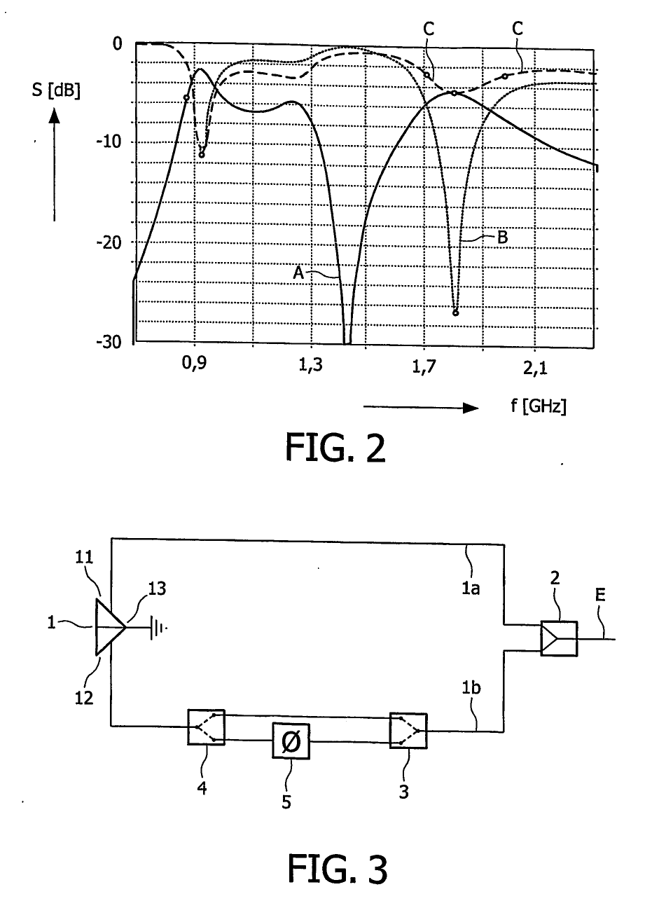

FIG. 2 shows the course of various scattering parameters of the antenna.

FIG. 3 shows a block diagram of the antenna module.

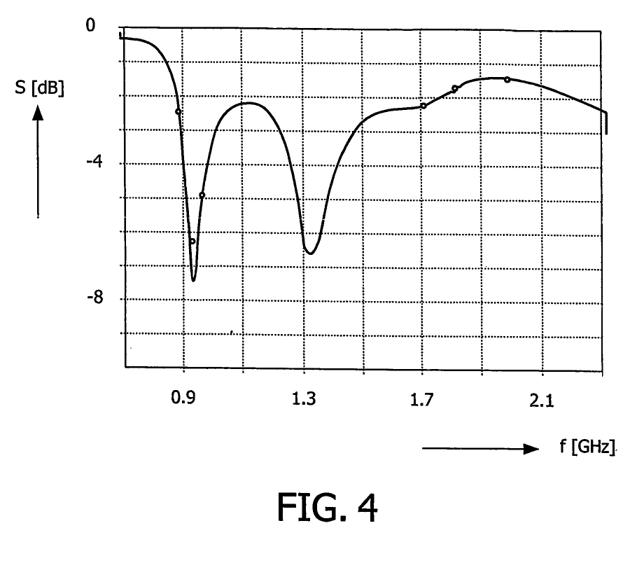

FIG. 4 shows the course of the scattering parameter of the antenna module in a first frequency band.

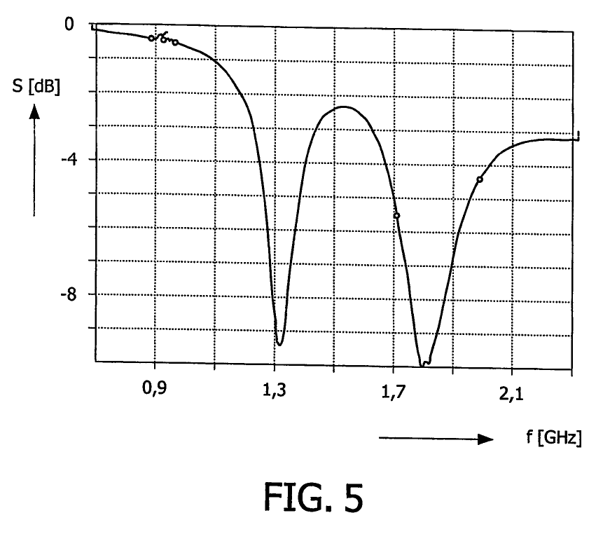

FIG. 5 shows the course of the scattering parameter of the antenna module in a second frequency band.

FIG. 1 shows a plan view of part of the front of a printed circuit board (PCB) 30 comprising a ground metallization 31 that forms a ground potential, said ground metallization preferably being applied to the rear. In one corner of the circuit board 30 in which the ground metallization 31 has been left out, there is an antenna 1 which forms part of an antenna module according to the invention.

The antenna 1 is a dielectric block antenna (DBA) or printed wire antenna (PWA). However, the antenna module according to the invention can also be produced with other antenna types, in particular as mentioned in the introduction. Furthermore, it may be dimensioned not only for the frequency ranges mentioned below but also for other frequency ranges, such as in particular the frequency ranges mentioned in the introduction.

As shown in FIG. 1, the antenna 1 has a first terminal 11 which is provided as a direct and constant HF input (or output) for the HF power that is to be emitted (or received). The antenna 1 furthermore comprises a second terminal 12 which is a control input and via which a variable control signal is fed to the antenna 1, and also a third terminal 13 which is connected to the ground metallization 31 and is thus at ground potential.

The antenna 1 furthermore comprises a substrate 10 which essentially has the shape of a square block, the length or width of which is about 3 to 40 times greater than its height. In the description which follows, the upper (large) surface of the substrate 10 (shaded gray) shown in FIG. 1 is therefore referred to as the upper main surface, the opposite surface is referred to as the lower main surface and the surfaces perpendicular thereto are referred to as the side surfaces of the substrate 10.

Instead of a square substrate 10, depending on the particular application and the available space it is also possible for a different geometric shape to be selected, for example a round or triangular or polygonal cylinder shape. Furthermore, the substrate 10 may also comprise cavities or recesses in order for example to save material and hence weight.

The substrate 10 is made for example from a ceramic material and/or one or more high frequency plastics or by embedding a ceramic powder in a polymer matrix. It is also possible to use pure polymer substrates. The materials should have as low losses as possible and a small temperature-dependence of the high frequency properties (NP0 or so-called SL materials).

In order to reduce the size of the antenna, the substrate 10 preferably has a dielectric constant of ∈^{r}>1 and/or a relative permeability of μᵣ>1. However, account should be taken of the fact that the achievable bandwidth decreases in the case of substrates having a high or rising dielectric constant and/or relative permeability.

In the case of the antenna 1 shown in FIG. 1, the substrate 10 is made of an NP0 ceramic having a dielectric constant of about 21.5, and has a length of about 15 mm, a width of about 15 mm and a height of about 2 mm.

The substrate 10 has on its surface a number of metallization structures which are formed of a highly electrically conductive material such as, for example, silver, copper, gold, aluminum or a superconductor. Individual metallization structures or a number of such metallization structures may also be embedded in the substrate 10 with appropriate contacting.

As shown in FIG. 1, the substrate 10 has at least one resonant first metallization structure 14 which extends in the form of a number of line sections along the lower main surface, one side surface and the upper main surface of the substrate 10. The course and electrically active length L′ of L/\sqrt{∈ᵣ} (where L is the wavelength of the signal in free space) of this first metallization structure 14 is selected in a known manner such that it essentially (i.e. together with the dielectric constant of the substrate) determines the lowest mode of the antenna, where L is the wavelength of the signal in free space. The first metallization structure 14 is dimensioned such that its length corresponds to about half the wavelength with which the antenna is to emit and receive electromagnetic power in the lowest mode. This lowest mode at the same time defines the lowest operating frequency of the antenna module (usually the GSM900 or AMPS band).

The first metallization structure 14 is connected to the ground metallization 31 via the third terminal 13 of the antenna.

By means of coupling mechanisms between parts of this metallization structure 14 on the lower and upper main surfaces of the substrate 10 (and possibly further metallization structures), the first harmonic of the antenna module can be shifted into a desired second frequency band which may for example be the DCS 1800 and/or PCS 1900 band. Dual band or multiband antennas can thereby be produced in a manner known per se.

As can be seen in FIG. 1, there is a second metallization structure 15 on the substrate 10, which second metallization structure has the form of a relatively short line section and is arranged opposite the end of the first metallization structure 14 and connected to the first terminal 11 of the antenna 1.

As shown in FIG. 1, there is finally a third metallization structure 16 on the substrate 10, which third metallization structure is designed in the form of a relatively short line section and is connected to the second terminal 12 of the antenna 1.

By means of capacitive coupling mechanisms between the first and second (functional) terminals 11, 12 (or the metallization structures 15, 16 that are connected to them in each case) and the first (resonant) metallization structure 14, the input impedance of the antenna 1 can be set to a desired value, usually 50 Ohms, in a manner known per se.

As an alternative to such a substrate antenna, it is also possible, in particular at frequencies of about 2 GHz or more, to omit the substrate 10 and apply the antenna, that is to say the metallization structures, for example directly to the circuit board 30 and to produce the terminals via capacitive coupling mechanisms, for example using SMD capacitors on the circuit board 30. Since the material of the circuit board 30 usually has a dielectric constant of about 4, although materials for the circuit board having a dielectric constant of about 10 are also known, the resonant metallization structure need be changed only insignificantly, in particular extended.

FIG. 2 shows various resonance spectra of the antenna 1 shown in FIG. 1 without external wiring, that is to say the terminals 11, 12, 13 of the antenna 1 have in each case been actuated in an alternating manner, where the terminal which in each case was not actuated was cut off with a resistance of 50 Ohms.

In detail, curve A shows the course of scattering parameter s₁₁ on the second terminal 12 (scattering terminal), curve B shows the course of the scattering parameter s₂₂ on the first terminal 11 (HF input or output) and curve C shows the scattering parameter s₂₁ or s₁₂ of the transmission between the first terminal 11 and the second terminal 12, in each case as a function of the frequency.

The relatively high impedance bandwidth of the resonance curves can be seen in FIG. 2, this in principle allowing operation of the antenna in the three bands GSM900, DCS1800 and PCS1900.

It has furthermore been found that the efficiency of the antenna 1 can be considerably increased or optimized by the actuation of the second terminal 12 (control input) and first terminal 11 (HF input) as described below.

If, for example at a frequency of 920 MHz (GSM900 or AMPS), the high frequency signal is applied exclusively to the second terminal 12, an efficiency of 32.9 percent is obtained. If the high frequency signal is applied exclusively to the first terminal 11, an efficiency of 37.2 percent is obtained. If, on the other hand, the high frequency signal is split in terms of its power and applied to the first terminal 11 and the second terminal 12 in a proportion of 50 percent each, given a phase shift of 0 degrees between the two signal components an efficiency of 69.2 percent is obtained. This corresponds to an increase in efficiency of almost 100 percent.

If, however, in comparison thereto the phase shift between the two signal components is 180 degrees, an efficiency of only 1.92 percent is obtained.

A further example is given for a frequency of 1820 MHz (DCS 1800/PCS 1900). In this case, an efficiency of 31.1 percent is obtained when the high frequency signal is applied exclusively to the second terminal 12. If, however, the high frequency signal is applied exclusively to the first terminal 11, an efficiency of 63.9 percent is obtained. If the power of the high frequency signal is split in a proportion of 50 percent each on the two terminals 11, 12, given a phase shift of 0 degrees between the two high frequency signals an efficiency of only 15.9 percent is obtained, whereas in the case of a phase shift by 180 degrees an efficiency of 79.0 percent was measured (that is to say an increase in efficiency of approximately 66 percent).

Whereas, therefore, in the case of the first (low) frequency the increase in efficiency was achieved with a phase shift of 0 degrees, in the case of the second (higher) frequency a phase shift of 180 degrees was necessary.

It has furthermore been found that the efficiency can be particularly considerably increased if the isolation between the first and second terminals 11, 12 of the antenna 1 does not significantly fall below or exceed a specific value of around 5 dB.

The improvement in efficiency is particularly high when this isolation is in the region of 5 dB plus/minus 2 dB.

FIG. 3 shows, by way of example, a block diagram of an antenna module according to the invention.

The module includes the antenna 1 shown in FIG. 1 with its first, second and third terminals 11, 12, 13, the third terminal 13 of the antenna 1 once again being connected to the ground metallization of the circuit board.

The antenna module comprises at its input a power splitter 2 connected to an HF connection E, to which the HF power to be emitted is fed or via which the HF power received is dissipated.

By means of the power splitter 2, the HF power is split preferably in a ratio of 50:50. A first output of the power splitter 2 is connected to a first branch 1a which is connected to the first terminal (HF input) 11 of the antenna 1.

The second output of the power splitter 2 is connected to a second branch 1b which leads to the second terminal (control input) 12 of the antenna 1 and comprises a first changeover switch 3, a second changeover switch 4 and a phase shifter 5, by means of which an applied signal can be shifted in terms of its phase preferably by 180 degrees.

In detail, the second output of the power splitter 2 is connected to a switching contact of the first changeover switch 3. A first output of the first changeover switch 3 is connected to a first input of the second changeover switch 4, whereas a second output of the first changeover switch 3 is connected to an input of the phase shifter 5. The output of the phase shifter 5 is connected to a second input of the second changeover switch 4. The switching contact of the second changeover switch 4 is finally connected to the second terminal 12 of the antenna 1.

By means of this circuit it is possible, by jointly actuating the first and second changeover switches 3, 4, to lead the HF power present at the second output of the power splitter 2 to the second terminal 12 (control input) of the antenna 1 either directly (first switch positions) or in a manner phase-shifted by 180 degrees (second switch positions).

The choice of first or second switch positions is made as a function of the frequency range used as mentioned above, in each case such that an optimal efficiency of the antenna 1 is obtained. In the case of the GSM900 band (920 MHz), therefore, the first switch positions would be selected, and the second switch positions would be selected in the case of the DCS1800/PCS1900 band (1820 MHz).

FIGS. 4 and 5 shows the courses of the scattering parameters (reflections), measured on the first terminal 11 of the antenna 1 as a function of the frequency for these two frequency bands. FIG. 4 shows the course resulting for the first switch positions (no phase shift) and FIG. 5 shows the course resulting for the second switch positions (180 degrees phase shift).

The Figures show that in the first switch positions a pronounced minimum is obtained at about 920 MHz and at about 1320 MHz, whereas in the second switch positions a minimum can be seen at about 1320 MHz and at about 1800 MHz. The antenna module according to the invention can thus be operated in 3 frequency bands, wherein the two changeover switches 3, 4 have to be operated in order to choose the lower and upper frequency bands.

It should be pointed out that the circuit shown in FIG. 3 may of course also be implemented in a different way in order to obtain the above-described functionality.

Finally, it should also be pointed out that by combining a number of antennas or antenna modules and actuating them in a phase-shifted manner by means of an HF signal that is to be transmitted, it is also possible for the directional characteristic of the overall arrangement to be set or changed.

1. An antenna module, in particular for the high frequency and microwave range, comprising at least one antenna (1) having at least a first terminal (11) and a second terminal (12), and a circuit arrangement (2, 3, 4, 5) for splitting an HF connection (E) to the antenna (1) onto at least a first branch (1a) and a second branch (1b) which are connected to the first and second terminals (11, 12) of the antenna (1), respectively.

2. An antenna module as claimed in claim 1, in which the circuit arrangement has a power splitter (2) for splitting the HF power present on the HF connection (E) onto the first and second branches (1a, 1b).

3. An antenna module as claimed in claim 2, in which the HF power that is present can optionally be split in a ratio of approximately 100:0 or approximately 50:50 by means of the power splitter (2).

4. An antenna module as claimed in claim 1, in which a phase shifter (5) for producing a phase shift between the HF signals fed into the two branches (1a, 1b) can be connected in one of the branches (1a, 1b).

5. An antenna module as claimed in claim 1, in which the antenna (1) has a ceramic substrate (10) with at least one resonant first metallization structure (14).

6. An antenna module as claimed in claim 5, in which the antenna (1) has a second metallization structure (15) for capacitively coupling the first terminal (11) to the first metallization structure (14).

7. An antenna module as claimed in claim 5, in which the antenna (1) has a third metallization structure (16) for capacitively coupling the second terminal (12) to the first metallization structure (14).

8. An antenna module as claimed in claim 1, in which the isolation between the first terminal (11) and the second terminal (12) is about 5 dB.

9. An antenna module as claimed in claim 1, in which the antenna is produced in the form of at least one resonant printed line structure and is applied together with the circuit arrangement (2, 3, 4, 5) to a circuit board (30).

10. A printed circuit board, in particular for the surface mounting of electronic components, comprising an antenna module as claimed in claim 1.

11. A mobile telecommunication device comprising an antenna module as claimed in claim 1.
